(19) United States
(12) Patent Application Publication
(10) Pub. No.: US 2003/0081582 A1
(43) Pub. Date: May 1, 2003

(54) Aggregating multiple wireless communication channels for high data rate transfers

(76) Inventors: Nikhil Jain, San Diego, CA (US); Aziz Gholmieh, San Diego, CA (US); Durga P. Malladi, San Diego, CA (US); Michael K. Spartz, San Diego, CA (US); Sivaramakrishna Veerpalli, Poway, CA (US)

Correspondence Address: QUALCOMM Incorporated, Attn: Patent Department, 5775 Morehouse Drive, San Diego, CA, 92121-1714, US

(21) Appl. No.: 10/271,930

(22) Filed: Oct. 15, 2002

Related U.S. Application Data
(60) Provisional application No. 60/335,680, filed on Oct. 25, 2001.

(51) Int. Cl. H04Q 7/24

(52) U.S. Cl. 370/338; 370/342; 370/352

(57) ABSTRACT

A mobile wireless terminal (MWT) receives IP packets destined for a ground network in a predetermined sequence order. The MWT fragments each of the IP packets into many smaller packet fragments, appends identifying information to each of the packet fragments, and transmits the packet fragments in parallel with one another over concurrently operating satellite channels. A receiving station receives the packet fragments transmitted by the MWT. The receiving station forwards the received packet fragments to a ground controller over a network connection, based on the identifying information appended to the packet fragments. The ground controller combines the packet fragments into reconstructed IP packets based on the identifying information appended to the fragments. The ground controller also sequences the reconstructed IP packets in the predetermined sequence order based on the identifying information. The ground controller forwards the reconstructed IP packets in the correct sequence order to the destination ground network. The same sequence of events occur in the opposite direction as well i.e., from the ground controller to the MWT.

### RELATED APPLICATIONS

This application claims priority from U.S. Provisional Patent Application entitled “Method and System for Aggregating Multiple Wireless Communication Channels for High Data Rate Transfers,” Serial No. 60/335,680, filed Oct. 25, 2001, which application is incorporated herein by reference in its entirety.

### BACKGROUND OF THE INVENTION

I. Field of the Invention

The present invention relates to wireless communication systems, and more particularly, to such a system operable in a data network environment.

II. Background Art

As mobile communication systems become more prevalent in use, the demands for greater and more sophisticated services have grown. To meet the capacity needs of mobile communication systems, techniques of multiple access to a limited communication resource have been developed. The use of code division multiple access (CDMA) modulation techniques is one of several techniques for facilitating communications in which a large number of system users are present. Other multiple access communication system techniques, such as time division multiple access (TDMA) and frequency division multiple access (FDMA) are known in the art.

The use of CDMA techniques in a multiple access communication system is known in the art and is disclosed in U.S. Pat. No. 4,901,307, issued Feb. 13, 1990, entitled “Spread Spectrum Multiple Access Communication System Using Satellite Or Terrestrial Repeaters”, assigned to the assignee of the present invention.

A known satellite communication system advantageously provides wireless connectivity between geographically-spaced user terminals over a satellite communication channel or link. An exemplary CDMA based satellite communication system is disclosed in U.S. Pat. No. 5,812,538, issued Sep. 22 1998, entitled “Multiple Satellite Repeater Capacity Loading With Multiple Spread Spectrum Gateway Antennas,” assigned to the assignee of the present invention. The user terminals can exchange data with one another at a maximum data rate, limited by the data transmission bandwidth of the satellite communication link. There is an ever pressing need to increase the data transmission bandwidth, and thus, the maximum data rate at which the user terminals can exchange data over the wireless communication link.

It is common place for computer clients and servers to communicate with one another over a data network connection, such as an Internet connection. It is desirable to establish such a connection using a wireless link, such as a satellite communication link, thereby enabling network connectivity between mobile clients and servers. It is also desirable to maximize data transmission bandwidth when using such a wireless network connection, for the reason mentioned above.

The above mentioned client and server can exchange data packets with one another over a network connection between the client and the server, using protocols selected from the IP protocol suite, such as TCP/IP. Such data packets are referred to as IP data packets (or IP packets). The network connection can cause some re-ordering of the IP packets flowing between the client and server, since different IP packets may be routed between the client and the server over different network routes. For the reason mentioned above, it can be desirable to include a wireless link in the network connection.

Some wireless links, including the above-mentioned satellite communication link, implement important error correction protocols to ensure reliable wireless data transmission. The error correction protocols can cause further IP packet re-ordering as the IP packets flow across the network connection. As a result, IP packets transmitted by the client in a predetermined sequence order may arrive at the server in an out-of-order sequence. Such cumulative IP packet re-ordering can invoke various TCP/IP error correction mechanisms, such as IP packet re-transmissions, that disadvantageously reduce the data transmission bandwidth of the network connection. Therefore, there is a need to route IP packets between a client and a server over a network connection including a reliable wireless link, such as a satellite communication link, so as to avoid cumulative IP packet re-ordering, and to thereby maintain high data rate transfers between the client and the server.

### BRIEF SUMMARY OF THE INVENTION

The present invention is a method for transferring IP packets in a wireless communication system by aggregating multiple wireless communication channels, such as satellite communication channels, into a common communication link to increase the effective data transmission bandwidth of the channels, and thus, the maximum data rate at which user terminals can exchange data over the common communication link.

The present invention can be used to establish a network connection between end-user terminals (such as a client and a server) over a wireless link, such as a satellite communication link, thereby enabling network connectivity between mobile clients and servers. The present invention maximizes data transmission bandwidth when using such a wireless network connection, to achieve high data rate transfers.

The present invention routes IP packets between the end-user terminals (for example, the client and the server) over a network connection including a reliable wireless link, such as a satellite communication link, in such a manner as to avoid cumulative IP packet re-ordering, thereby maintaining high data rate transfers between the end-user terminals.

The present invention aggregates multiple, reliable wireless communication links into a common communication channel operating in a network environment, such as the Internet, in such a way as to be transparent to standard network protocols, such as TCP/IP.

An example system of the present invention aggregates communication channels carrying IP packets flowing from a mobile portion of the present invention to a ground portion of the present invention. The mobile portion includes a mobile wireless terminal (MWT). The MWT receives IP packets destined for a ground network, from a network in the mobile portion. The MWT receives the IP packets from the mobile network in a predetermined sequence order. The MWT fragments each of the IP packets into many smaller packet fragments, appends identifying information to each of the packet fragments, and transmits the packet fragments in parallel with one another over concurrently operating satellite channels.

The ground portion includes a receiving station, such as a gateway station, and a ground controller, connected to the gateway station over one or more data networks. The receiving station wirelessly receives the packet fragments transmitted by the MWT. The receiving station forwards the received packet fragments to a ground controller over a network connection, based on the identifying information appended to the packet fragments. The packet fragments often arrive substantially out-of-order at the receiving station and the ground controller.

The ground controller combines the packet fragments into reconstructed IP packets based on the identifying information appended to the fragments. The ground controller also sequences the reconstructed IP packets in the predetermined sequence order based on the identifying information. The ground controller forwards the reconstructed IP packets in the correct sequence order to the destination ground network.

The example system aggregates communication channels carrying IP packet fragments flowing from the ground portion to the mobile portion, as well as in the opposite direction. Therefore, the mobile portion, for example, the MWT, implements both transmit and receive methods of aggregating channels, according to the present invention. Similarly, the ground portion, for example, the receiving station and ground controller together, also implements receive and transmit methods of aggregating channels, according to the present invention.

One embodiment of the invention is a transmission method which uses aggregation of multiple CDMA communication channels. The transmit method comprises receiving at least one IP data packet, fragmenting the IP data packet into a plurality of packet fragments smaller than the IP data packet, adding a fragment identifier (ID) and a packet sequence ID to each packet fragment, adding an IP header to each packet fragment, where the IP header includes a source IP address which is the IP address associated with the channel over which the packet is transmitted, and a destination IP address which is the IP address of the ground controller, and wirelessly transmitting the plurality of packet fragments over a plurality of concurrently operating CDMA communication channels. The transmit method also includes receiving a plurality of IP data packets in a predetermined sequence order and performing the fragmenting through transmitting steps for each IP data packet such that each transmitted packet fragment includes a sequence ID of a corresponding one of the IP data packets received in the predetermined sequence order.

In further aspects of embodiments of the invention, wireless transmission encompasses concurrently transmitting at least two of the plurality of packet fragments over corresponding ones of the concurrently operating communication channels. The step of adding an IP header comprises adding a transport protocol header to each packet fragment in addition to the IP header, the transport protocol header corresponding to a respective one of the communication channels over which the packet fragment is to be transmitted.

Prior to wireless transmission each of the concurrently operating CDMA communication channels are set up, and each packet fragment is scheduled for transmission over a selected one of the plurality of concurrently operating CDMA communication channels. Such scheduling comprises selecting each said communication channel in a predetermined channel selection order, and scheduling packet fragments for transmission over a respective one of the communication channels selected in the predetermined channel selection order. Alternatively the scheduling comprises monitoring a data error rate associated with each of the communication channels, selecting a preferred set of communication channels based on the monitored data error rates, and scheduling the plurality of packet fragments for transmission over the preferred set of communication channels.

In another embodiment a receive method is provided for aggregating multiple CDMA communication channels. The receive method comprises wirelessly receiving a plurality of IP packet fragments over a plurality of concurrently operating CDMA communication channels, each IP packet fragment including a packet fragment ID, a packet sequence ID associating the IP packet fragment with an IP data packet, and an IP header including an IP address. The receive method further comprise routing each received IP packet fragment to the IP address included in the IP header, and combining the routed IP packet fragments into the associated IP data packet based on the fragment IDs and the packet sequence IDs. The plurality of received IP packet fragments can be associated with a plurality of different IP data packets. When this is the case, the receive method further comprises repeating the routing and combining steps for each of the different IP data packets to produce a plurality of reconstructed IP data packets, and sequencing the plurality of reconstructed IP data packets based on the packet sequence IDs.

In further aspects of embodiments of the invention, wireless reception encompasses concurrently receiving at least two of the plurality of packet fragments over corresponding ones of the concurrently operating communication channels.

In further aspects, the sequencing involves reordering the plurality of reconstructed IP data packets when the reconstructed IP data packets are out-of-order with respect to a predetermined sequence order indicated by the packet sequence IDs. When the plurality of IP packet fragments received are associated with a plurality of different IP data packets, the method further comprises repeating the routing and combining steps for each different IP data packet to produce a plurality of reconstructed IP data packets in a packet sequence ordered in accordance with the sequence IDs.

Another aspect of the present invention is an overall method of aggregating multiple CDMA communication channels combining both transmit and receive methods. The overall method comprises receiving at least one IP data packet, fragmenting the IP data packet into a plurality of packet fragments smaller than the IP data packet, adding a fragment ID and a packet sequence ID to each packet fragment, adding an IP header to each packet fragment, where the IP header includes a source IP address which is the IP address associated with the channel over which the packet is transmitted, and a destination IP address which is the IP address of the ground controller, and wirelessly transmitting the plurality of packet fragments over a plurality of concurrently operating CDMA communication channels. The overall method further comprises wirelessly receiving the plurality of IP packet fragments, routing each received IP packet fragment to the IP address included in the IP header, and recombining the routed IP packet fragments into the at least one IP data packet based on the fragment IDs and the packet sequence IDs.

Yet another aspect of the present invention is a transmit system used for aggregating multiple CDMA communication channels. The transmit system comprises one or more controllers adapted to receive at least one IP data packet, where at least one of the controllers has a fragmenter that fragments the IP data packet into a plurality of packet fragments smaller than the IP data packet, and adds a fragment ID and a packet sequence ID to each packet fragment. The fragmenter also includes an IP module that adds an IP header including an IP address to each packet fragment. The transmit system further includes a plurality of wireless modems or transceiver elements or modules adapted to wirelessly transmit the plurality of packet fragments over corresponding ones of a plurality of concurrently operating CDMA communication channels.

In further aspects of this transmit system, one or more controllers are adapted to receive a plurality of IP data packets in a predetermined sequence order and the fragmenter is adapted to fragment each IP data packet into a plurality of smaller IP packet fragments and to add a fragment ID and a packet sequence ID to each fragment corresponding to the predetermined sequence order. The IP module is adapted to add an IP header including an IP address to each of the packet fragments.

The controllers can be adapted to cause at least two of the wireless modems to concurrently transmit at least two of the plurality of packet fragments over corresponding ones of the concurrently operating communication channels, and IP modules may be adapted to add a transport protocol header to each packet fragment in addition to the IP header, the transport protocol header corresponding to a respective one of the wireless modems and communication channels over which the packet fragment is to be transmitted. One or more controllers and wireless modems may reside in a mobile wireless terminal. Alternatively, one or more controllers may be divided among a gateway station and a ground controller both connected to one or more ground-based packet data networks, and the wireless modems reside in the gateway station.

Furthermore, at least one of the controllers includes a scheduler that schedules packet fragments for transmission over a selected one of the plurality of concurrently operating CDMA communication channels. The scheduler includes means for selecting each communication channel in a predetermined channel selection order, and means for scheduling each packet fragment for transmission over respective ones of the communication channels in the predetermined channel selection order. In addition, at least one of the controllers can include means for monitoring a data error rate associated with each of the communication channels. In this case, the scheduler includes means for selecting a preferred set of communication channels from the plurality of communication channels based on the monitored data error rates, and means for scheduling the plurality of packet fragments for transmission over the preferred set of communication channels.

A further aspect of embodiments of the invention is a receive system for aggregating multiple CDMA communication channels. The receive system includes a plurality of wireless modems adapted to wirelessly receive a plurality of IP packet fragments over a plurality of concurrently operating CDMA communication channels, each of the communication channels corresponding to a respective one of the wireless modems, each of the packet fragments including a fragment ID, a packet sequence ID associating the IP packet fragment with an IP data packet, and an IP header including an IP address. The receive system also includes one or more controllers, where at least one of the one or more controllers has means for routing each received packet fragment to the IP address included in the IP header, and a defragmenter that recombines the routed IP packet fragments into the associated IP data packet based on the fragment IDs and the packet sequence IDs.

The wireless modems may be adapted to concurrently receive at least two of the plurality of packet fragments over corresponding ones of the concurrently operating communication channels. One or more controllers and the wireless modems may reside in a mobile wireless terminal and establish each of the concurrently operating CDMA communication channels.

In further aspects of the invention, the plurality of packet fragments are associated with a plurality of different IP data packets, and the routing means is adapted to route each of the packet fragments to the IP address of the channel over which it is transmitted while the defragmenter is adapted to recombine the routed packet fragments into associated IP data packets to produce a plurality of reconstructed IP data packets, and at least one controller includes a sequencer that sequences reconstructed IP data packets based on packet sequence IDs.

In further embodiments, controllers are divided among a gateway station and a ground controller both connected to one or more ground-based packet data networks, the ground controller having an IP address corresponding to the IP addresses included in the IP packet fragment header, and wherein the wireless modems reside in the gateway station.

An even further aspect of the present invention is an overall transmit-receive system for aggregating multiple CDMA communication channels. The overall system includes elements from the receive and transmit systems described above.

| | |
|---|---|
| IP | Internet Protocol. |
| PPP | Point-to-Point Protocol. |
| RLP | Radio Link Protocol. |
| TCP | Transaction Control Protocol. |
| UDP | User Datagram Protocol. |

### BRIEF DESCRIPTION OF THE DRAWINGS

The features, objects, and advantages of the present invention will become more apparent from the detailed description set forth below when taken in conjunction with the drawings in which like reference characters identify the same or similar elements throughout and wherein:

FIG. 1A is an illustration of an example satellite communication system suitable for use.

FIG. 1B is a block diagram of a satellite from the system of FIG. 1A.

FIG. 2 is a block diagram of an example system for aggregating multiple Code Division Multiple Access satellite communication channels to achieve medium and high data rate transfers.

FIG. 3 is an illustration of receive/transmit reciprocity between a mobile portion and a ground portion of the system of FIG. 2.

FIG. 4 is a flow chart of an example transmit method of aggregating multiple communication channels performed in the system of FIG. 2.

FIG. 5 is a flow chart of further example transmit method steps expanding on the method of FIG. 4.

FIG. 6 is a flow chart of an example transmit scheduling method.

FIG. 7 is a flow chart of an alternative example transmit scheduling method.

FIG. 8 is an illustration of portions of the transmit method from FIG. 4 along with an exemplary series of packet fragments produced by the method, useful for describing embodiments of the invention.

FIG. 9 is a flow chart of an example receive method of aggregating multiple communication channels performed in the system of FIG. 2.

FIG. 10 is a flow chart of further receive method steps expanding on the method of FIG. 9.

FIG. 10A is a flow chart of an example system method implemented in the system of FIG. 2.

FIG. 11 is an illustration of an alternative, example receive method, in combination with the transmit method steps depicted in FIG. 8, and in further combination with illustrative transmit and receive series of packet fragments resulting from the transmit and receive methods, respectively.

FIG. 12 is a diagram of exemplary layered protocol connections between various elements of the system of FIG. 2.

FIG. 13 is an illustration of exemplary UDP/IP data tunnels connecting an MWT and a ground controller of the system of FIG. 2.

FIG. 14 is a functional block diagram of an example MWT controller of the system of FIG. 2.

FIG. 15 is a block diagram of an example computer system for implementing the methods of the embodiments.

### DETAILED DESCRIPTION OF EMBODIMENTS OF THE INVENTION

### I. Exemplary Satellite System

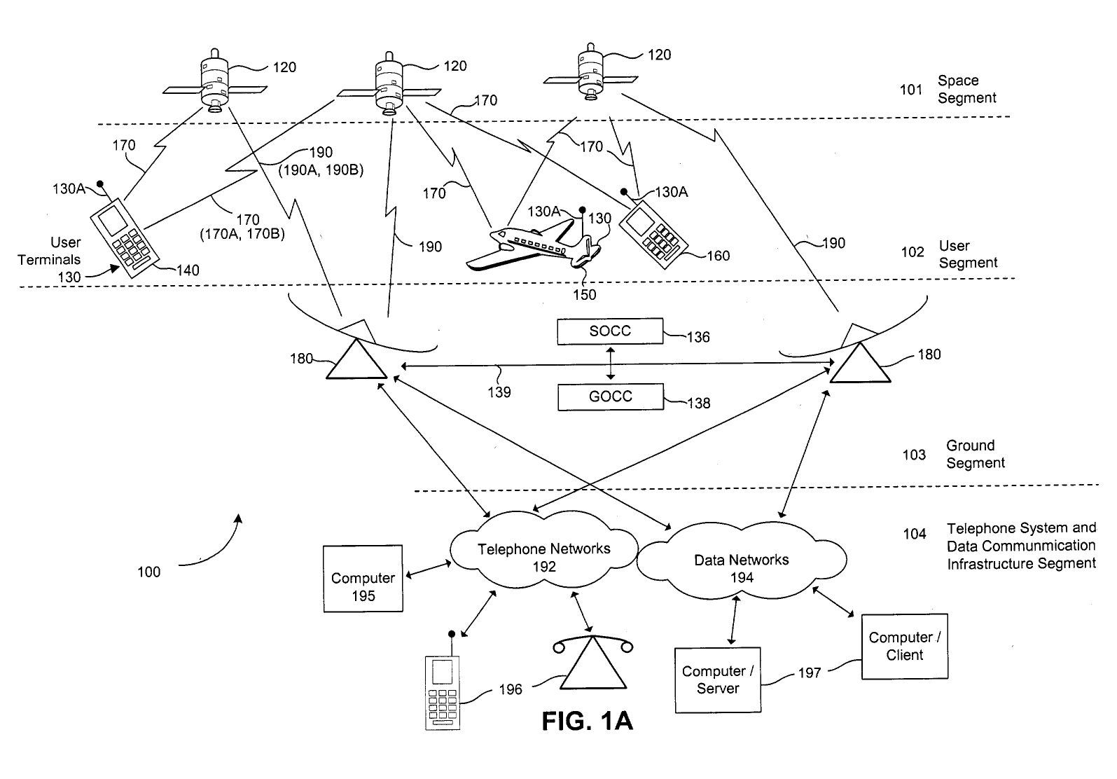

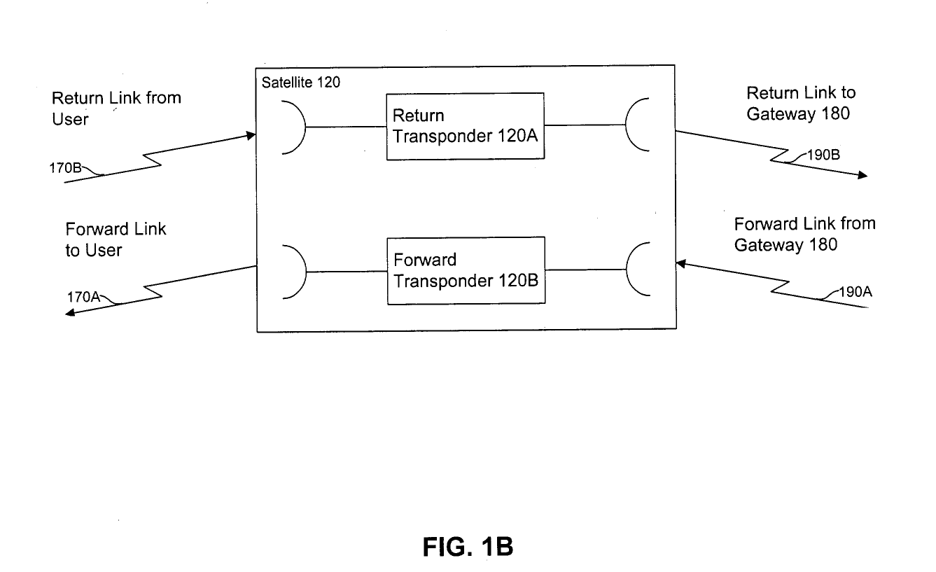

FIG. 1A is an illustration of an example satellite communication system 100 suitable for use with embodiments of the invention. Before describing embodiments in detail, a description will first be made of communication system 100 to enable a more complete understanding of the present invention. The communication system 100 may be conceptually sub-divided into a plurality of segments 101, 102, 103 and 104. Segment 101 is referred to herein as a space segment, segment 102 as a user segment, segment 103 as a ground (terrestrial) segment, and segment 104 as a telephone system or a data network infrastructure segment. Example satellite communication system 100 includes a total of 48 satellites 120 in, by example, a 1414 km Low Earth Orbit (LEO). Satellites 120 are distributed in orbits so as to provide approximately full-earth coverage with, preferably, at least two satellites in view at any given time from a particular user location between about 70 degree south latitude and about 70 degree north latitude. As such, a user is enabled to communicate to or from nearly any point on the earth's surface within a gateway (GW) 180 coverage area to or from other points on the earth's surface (by way of the Public Switched Telephone Network (PSTN)), via one or more gateways 180 and one or more of the satellites 120, possibly also using a portion of the telephone system and data network infrastructure segment 104.

It is noted at this point that the foregoing and ensuing description of the system 100 represents but one example of a communication system within which the teaching of this invention may find use. That is, the specific details of the communication system are not to be read or construed in a limiting sense upon the practice of this invention. Other types of satellites and constellations including MEO or GEO elements could be used, or other moving sources or receivers (such as on planes and trains) could also be used where data transfer is desired.

Continuing now with a description of the system 100, a soft transfer (handoff) process between satellites 120, and also between individual ones of 16 beams transmitted by each satellite, provides unbroken communications using a spread spectrum (SS), code division multiple access (CDMA) technique. The presently preferred SS-CDMA technique is similar to the TIA/EIA Interim Standard, “Mobile Station-Base Station Compatibility Standard for Dual-Mode Wideband Spread Spectrum Cellular System” TIA/EIA/IS-95, July 1993, although other spread spectrum and CDMA techniques and protocols, or even some types of Time Division Multiple Access (TDMA) systems can be employed. Aside from CDMA cellular systems described in the Telecommunications Industry Association/Electronic Industries Association (TIA/EIA) Standard IS-95. one can see combined AMPS & CDMA systems described in the TIA/EIA Standard IS-98. Other communications systems are described in the International Mobile Telecommunications System 2000/Universal Mobile Telecommunications System or IMT-2000/UM standards, covering what are commonly referred to as wideband CDMA (WCDMA), cdma2000 (such as cdma2000 1x-rxtt cdma2000 1x, 3x, or MC standards, for example) or TD-SCDMA. Satellite based communication systems also utilize these or similar known standards.

The use of low earth orbits permits low-powered fixed, portable, or mobile wireless user terminals 130 to communicate through the satellites 120, each of which functions, by way of example, as a “bent pipe” repeater to receive a communications traffic signal (such as speech and/or data) from a user terminal 130 or from a gateway 180, convert the received communications traffic signal to another frequency band, as needed, and to then re-transmit the converted signal.

The user segment 102 may include a plurality of types of user terminals 130 that are adapted for communication with the satellites 120. The user terminals 130 each have or include, by example, a plurality of different types of fixed and mobile user terminals including, but not limited to, a cellular telephone, wireless handset, a data transceiver, or a paging or position determination receiver, or mobile radio-telephones. Furthermore each of user terminals 130 can be hand-held, portable as in vehicle-mounted (including for example cars, trucks, boats, trains, and planes), or fixed, as desired. For example, FIG. 1 illustrates user terminals 140 as hand-held devices, user terminals 150 as a vehicle-mounted devices, and user terminals 160 as paging/messaging-type devices and fixed radio-telephones. Wireless communication devices are also sometimes referred to as user terminals, mobile stations, mobile units, subscriber units, mobile radios or radiotelephones, wireless units, or simply as ‘users,’ ‘subscribers,’ ‘terminals,’ and ‘mobiles’ in some communication systems, depending on preference. The user terminals 130 are preferably provided with omni-directional antennas 130A for bi-directional communication via one or more of the satellites 120. Each of antennas 130A may be an antenna assembly including separate transmit and receive antennas.

Referring also to FIG. 1B, the user terminals 130 may be capable of operating in a full duplex mode and communicate via, by example, L-band RF links (uplink or return link 170B) and S-band RF links (downlink or forward link 170A) through return and forward satellite transponders 120A and 120B, respectively. The return L band RF links 170B may operate within a frequency range of 1.61 GHz to 1.625 GHz, a bandwidth of 16.5 MHz, and are modulated with packetized digital voice signals and/or data signals in accordance with the preferred spread spectrum technique. The forward S band RF links 170A may operate within a frequency range of 2.485 GHz to 2.5 GHz, a bandwidth of 16.5 MHz.

The forward RF links 170A are also modulated at a gateway 180 with packetized digital voice signals and/or data signals in accordance with the spread spectrum technique. The 16.5 MHz bandwidth of the forward link is partitioned into 16 beams with 13 sub-beams effectively forming 208 FDM channels, each further accommodating around 128 code channels, with one user being assigned per forward link code channel, plus pilot signals, and so forth. The return link may have various bandwidths, and a given user terminal 130 may or may not be assigned a different channel than the channel assigned on the forward link.

The ground segment 103 includes at least one but generally a plurality of the gateways 180 that communicate with the satellites 120 using, by example, a full duplex C-band RF link 190 (forward link 190A (to the satellite), return link 190B (from the satellite)) that operates within a range of frequencies generally above 3 GHz and preferably in the C-band. The C-band RF links bi-directionally convey the communication feeder links, and also convey satellite commands to the satellites and telemetry information from the satellites. The forward feeder link 190A may operate in the band of 5 GHz to 5.25 GHz, while the return feeder link 190B may operate in the band of 6.875 GHz to 7.075 GHz. As an example, several thousand full duplex communications may occur through a given one of the satellites 120. In accordance with a feature of the system 100, two or more satellites 120 may each convey the same communication between a given user terminal 130 and one of the gateways 180.

It is pointed out that all of the frequencies, bandwidths and the like that are described herein are representative of but one particular system. Other frequencies and bands of frequencies may be used with no change in the principles being discussed. As but one example, the feeder links between the gateways and the satellites may use frequencies in a band other than the C-band (approximately 3 GHz to approximately 7 GHz), for example the Ku band (approximately 100 GHz to approximately 15 GHz) or the Ka band (above approximately 15 GHz).

The gateways 180 function to couple the communications payload or transponders 120A and 120B (FIG. 1B) of the satellites 120 to the telephone system and data network infrastructure segment 104. Segment 104 includes telephone networks 192 and data networks 194, which might also be interconnected with the telephone networks, or just connected to gateways and base stations. Telephone networks 192 include private telephone systems and public telephone systems such as the PSTN, for example. Telephone networks 192 are coupled to computer terminals 195 and telephones 196. Data networks 194 include local and wide area packet switched data networks, the Internet, and Intranets, for example. Data networks 194 are coupled to computer terminals 197.

Also shown in FIG. 1A, as a portion of the ground segment 103, is a Satellite Operations Control Center (SOCC) 136, and a Ground Operations Control Center (GOCC) 138. A communication path, which includes a Ground Data Network (GDN) 139, is provided for interconnecting the gateways 180, SOCC 36 and GOCC 38 of the ground segment 103. This portion of the communications system 100 provides overall system control functions.

### II. System Overview

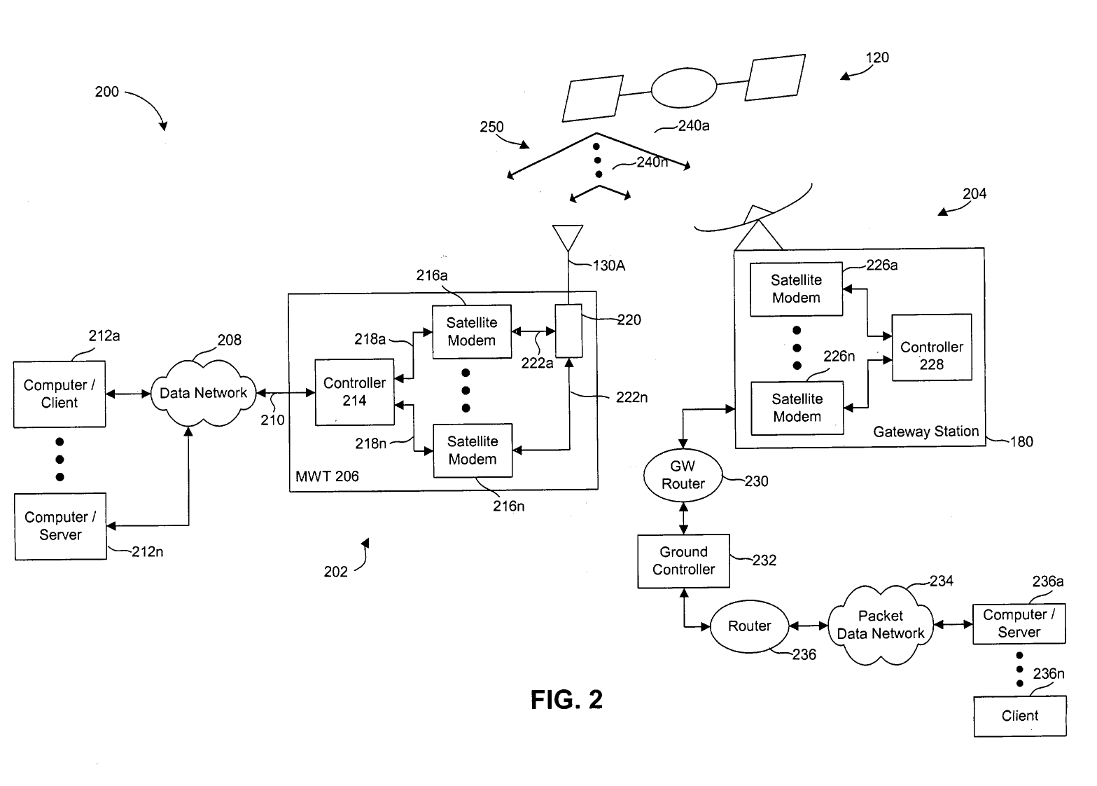

FIG. 2 is a block diagram of an example system 200 for aggregating multiple Code Division Multiple Access (CDMA) satellite communication channels to achieve medium and high data rate transfers. System 200 includes a mobile portion 202, one or more of satellites 120, and ground portion 204. In an exemplary configuration, mobile portion 202 is installed on a mobile platform such as an aircraft. However, other forms of transportation such as trains, ships, busses, or light rail, for example, may find advantage in using embodiments of the invention.

Mobile portion 202 includes a MWT 206 coupled to a data network 208 over a communication link 210 such as an Ethernet link, Bluetooth based wireless link, or using a wireless transfer system based on 802.11 (IEEE) standards protocols. One or more computer terminals 212a-212n are coupled to data network 208. The systems also contemplates the use of handheld or laptop computers having wireless or wire line modems, PDAs, facsimile and other data transfer devices, including, but not limited to, gaming devices, paging devices, and so forth, that desire to transfer data to a user. Data network 208 can be a Local Area Network (LAN), or any other known network. Data network 208 can include data routers and can be connected to other networks.

MWT 206 includes antenna 109A for transmitting signals to and receiving signals from ground portion 204. MWT 206 includes a controller (that is, one or more controllers or signal processors) 214 coupled to communication link 210. Controller 214 provides data-to-be transmitted to a plurality of satellite modems 216a-216n over a plurality of corresponding data links 218a-218n connected between controller 214 and satellite modems 216. Data connections 218 may be serial data connections. Satellite modems 216 provide RF signals to and receive RF signals from a power combining and splitting assembly 220, over a plurality of RF connections 222a-222n. Power combiner and splitter assembly 220 includes a transmit power amplifier for amplifying RF signals received from satellite modems 216. In a transmit direction, assembly 220 combines and power amplifies RF signals received from satellite modems 216, and provides a combined RF transmit signal to antenna 130A. In a receive direction, assembly 220 provides RF signals received from antenna 130A to respective ones of satellite modems 216.

Ground portion 204 includes gateway station 180 (also referred to as gateway 180) for transmitting signals to and receiving signals from mobile portion 202 over satellite 120. A gateway data router 230 connects gateway station 180 to one or more private and/or public packet data networks, including the Internet. Ground portion 204 also includes a ground controller 232 coupled to the aforementioned networks through gateway router 230. Ground controller 232 can serve multiple gateways 180. Ground controller 232 is coupled to one or more packet data networks 234, including the Internet, through a second data router 236. A plurality of computer terminals 236a-236n, or other devices are coupled with packet data networks 234. Other devices that can be connected to a remote network could include remote printers for printing photographs, facsimile devices, memory devices, security systems or surveillance systems allowing visual inspections by the user, and so forth, which typically use higher data rate transfers.

Gateway station 180 includes a plurality of satellite modems 226a-226n corresponding to satellite modems 216 of MWT 206. Gateway station 180 also includes a gateway controller (that is, one or more controllers) 228 for controlling satellite modems 226 and various functions within gateway station 180. Mobile portion 202 communicates with ground portion 204 over a plurality of CDMA satellite communication links 240a-240n established between MWT 206 and gateway station 180. Satellite communication links 240a-240n can operate concurrently with one another. Each of satellite communication link 240 supports satellite traffic channels for carrying data between MWT 206 and gateway 180 in the satellite uplink and downlink directions. Each of the satellite modems 216 in MWT 206 communicates with a corresponding one of satellite modems 226 in gateway station 180 over a corresponding one of the satellite communication links 240. For example, satellite modem 216a in MWT 206 exchanges data with satellite modem 226a in gateway 180 over satellite communication link 240a. The plurality of satellite communication channels 240 form part of an air interface 250 between MWT 206 and gateway station 180.

A brief operational overview of system 200 is now provided, followed by detailed descriptions of various aspects of embodiments of the invention. MWT 206 receives IP packets destined for ground network 234 from network 208. The IP packets are received in a predetermined sequence or sequential order. MWT fragments each of the IP packets into many smaller IP packet fragments, appends identifying information to each of the packet fragments, and transmits the packet fragments in parallel with one another over concurrently operating ones of satellite channels 240. Such parallel transmission advantageously reduces the time required to transmit each IP packet (albeit as multiple packet fragments) over air interface 250. Thus, the present invention advantageously increases data transmission/reception bandwidth relative to conventional systems that do not operate in the above described manner.

Gateway station 180 receives the transmitted packet fragments and forwards the received packet fragments to ground controller 232. The packet fragments often arrive substantially out-of-order, relative to the transmitted data stream, at gateway station 180 and ground controller 232 due to the operation of satellite link error correction protocols. Such error correction protocols cause packet fragment re-transmissions (from MWT 206 to gateway 180) when packet fragments are lost due to signal drop-outs or when received packet fragments are determined to be in error.

Ground controller 232 combines packet fragments into reconstructed IP packets based on the identifying information appended to the fragments. Ground controller 232 also sequences the reconstructed IP packets in the predetermined sequence order based on the identifying information. Ground controller 232 forwards the reconstructed IP packets in the correct sequence order to ground network 234. Ground network 234, operating under standard TCP/IP protocols, for example, can be intolerant to the above-mentioned packet fragment “out-of-order” transfer or re-ordering (due to re-transmission, etc.). However, the present invention advantageously isolates ground network 234 from such re-ordering because of the sequencing performed by ground controller 232.

In an exemplary arrangement of the present invention, each of the satellite communication channels has a data transmission bandwidth of approximately 9.6 Kilobits-per-second (Kbps). In the exemplary arrangement, up to twenty-four (24) satellite modems or transceiver modules 216, and thus twenty-four (24) satellite channels 240, operate concurrently, thereby achieving an aggregated transmission bandwidth of approximately 230 Kbps (24×9.6 Kbps=230.4 Kbps). More or less communication channels may be aggregated to achieve correspondingly different data transmission bandwidths.

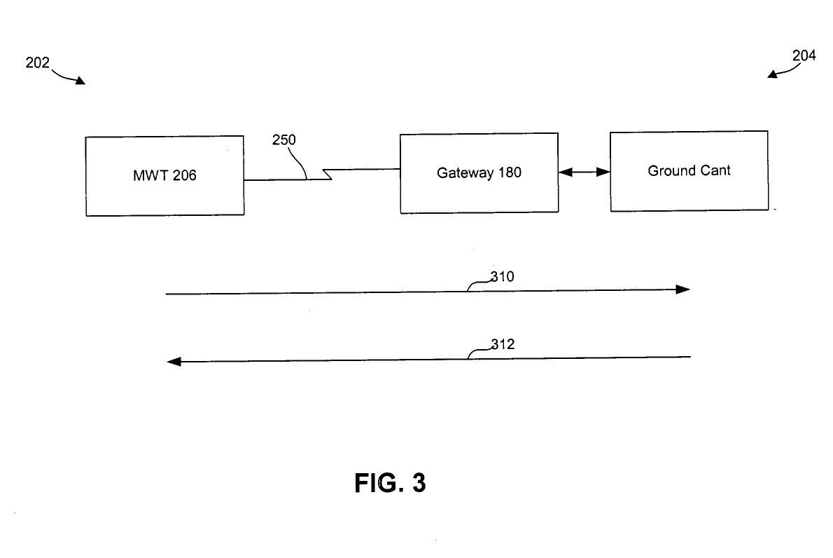

The above-described process also occurs in the reverse or reciprocal direction, that is, for IP packets originating from ground network 234 and destined for mobile network 208. However, for CDMA based communication systems the forward link uses code channels on the frequency division multiplexed (FDM) channels or sub-beams to distinguish users while on the reverse link user specific codes and an M-ARY modulation scheme are used on the sub-beams to distinguish users. FIG. 3 is an illustration of such receive/transmit reciprocity between mobile portion 202 and ground portion 204. To aggregate communication channels carrying data flowing from mobile portion 202 to ground portion 204 in a direction 310, MWT 206 executes transmit methods of the invention while gateway 180 and ground controller 232 together execute receive methods of the invention that are generally reciprocal to the transmit methods executed by MWT 206. To aggregate communication channels carrying data flowing from ground portion 204 to mobile portion 202 in a direction 312 (opposite from direction 310), gateway 180 and ground controller 232 together execute transmit methods of embodiments of the invention while MWT 206 executes receive methods of embodiments of the invention reciprocal to the transmit methods executed by ground portion 204.

The receive methods performed by MWT 206, and by gateway 180 and ground controller 232 together, are substantially the same, as are the transmit methods performed by MWT 206, and by gateway 180 and ground controller 232 together. For convenience and clarity, the transmit methods used by embodiments of the invention are described below primarily in the context of mobile portion 202 (for example, in MWT 206), however, it is to be understood that such methods are also implemented by ground portion 204 (for example, by gateway 180 and ground controller 232). Similarly, the receive methods of embodiments of the invention are described below primarily in the context of ground portion 204, however, it is to be understood that such methods are also implemented by mobile portion 202.

It is to be understood that the foregoing and ensuing descriptions are not to be construed so as to limit the present invention in any way. For example, the present invention may be used to aggregate multiple, terrestrial-based, wireless communication channels, such as CDMA cellular or Personal Communications Services (PCS) communication channels, to achieve high data rate transfers. In an exemplary terrestrial-based application of the present invention, an MWT may reside in a land-base vehicle, such as an automobile, and include a plurality of concurrently operating CDMA cellular/PCS modems or transceiver modules or elements instead of satellite modems. The MWT may exchange data with a cellular/PCS base station, including a plurality of concurrently operating CDMA cellular/PCS modems (instead of a satellite gateway), over a plurality of concurrently operating CDMA cellular/PCS communication channels.

### III. Transmit Methods

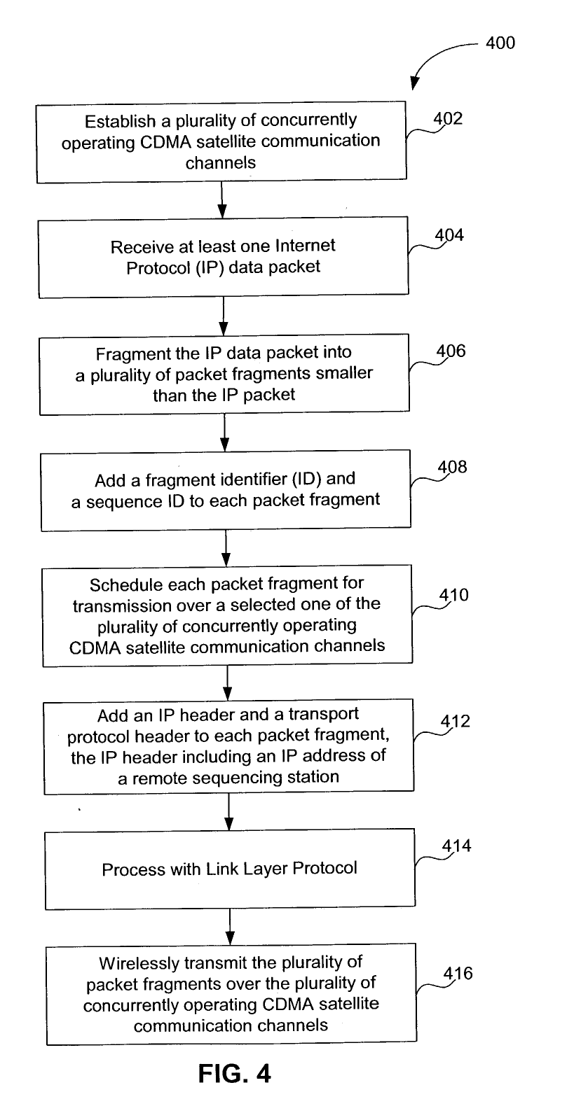

FIG. 4 is a flow chart of an example transmit method 400 of aggregating communication channels performed in mobile and ground portions 202 and 204. For convenience, transmit method 400 is described in the context of mobile portion 202, that is, in direction 310.

In an initial step 402 of method 400, MWT 206 establishes a plurality of concurrently operating CDMA satellite communication channels, such as communication links 240, with gateway station 180.

At a next step 404, MWT 206 receives at least one IP data packet from data network 208, for example, from one of computers 212. The IP packet can be destined for one of computer terminals 236 connected to ground network 234 of ground portion 204, and therefore, includes an IP address corresponding to such a destination.

At a next step 406, controller 214 fragments the IP data packet into a plurality of IP packet fragments each smaller than the IP packet. In one arrangement of the present invention, controller 214 fragments the IP packet into a number of IP packet fragments equal to the number of communication links 240a-240n. However, different numbers of fragments can be used, depending on the size of the IP packet, for example.

At a next step 408, controller 214 adds a fragment header to each packet fragment. The fragment header includes a fragment ID and an IP packet sequence ID. The fragment ID identifies the fragment within the IP packet with respect to the other packet fragments belonging to the IP packet. The IP sequence ID specifies a sequence order in which the IP packet (to which the IP packet fragment belongs) was received from network 208.

At a next step 410, controller 214 schedules each of the packet fragments for transmission over a selected one of the plurality of concurrently operating CDMA satellite communication channels 240. In doing so, controller 214 assigns each packet fragment to one of satellite modems 216 so each packet fragment can be transmitted by the modem to which it is assigned, over the corresponding one of satellite links 240.

At a next step 412, controller 214 adds an IP header to each packet fragment. The IP header includes a source IP address which is the IP address associated with the channel or satellite mode 216 over which the fragment is transmitted, and a destination IP address which is the IP address corresponding to an IP address of ground controller 232. At step 412, a transport protocol header, such as a UDP header, can be added to each packet fragment in addition to the IP header.

At a next step 414, controller 214 processes the packet fragments in accordance with a link layer protocol, such as PPP, for example. Controller 214 appends a link layer protocol header (for example, a PPP header) to each of the packet fragments.

Controller 214 optionally compresses the various headers appended to the packet fragments, mentioned above, to reduce the size of the packet fragments, and, thus, conserve data transmission bandwidth.

At a next step 416, MWT 206 transmits the plurality of packet fragments over the plurality of concurrently operating communication channels 240 using satellite modems 216. The plurality of packet fragments are preferably transmitted in parallel with one another, that is concurrently, over satellite channels 240 to reduce the amount of time taken to transmit the IP packet (as a collection of the packet fragments) to gateway station 180. Step 402 can be performed at any time before transmitting step 416.

Method 400 is also performed in ground portion 204, that is, in direction 312. In this context, ground controller 232 receives IP packets from data network 234 destined for one of computers 212 of mobile portion 202. For example, router 236 can forward the IP packet to ground controller 232. Ground controller 232 fragments the IP packets, appends the above mentioned headers to the packets, and forwards the packets to gateway station 180. The appended IP header includes an IP address corresponding to satellite modem 216. Gateway station 180 schedules and then transmits the packet fragments received from ground controller 232.

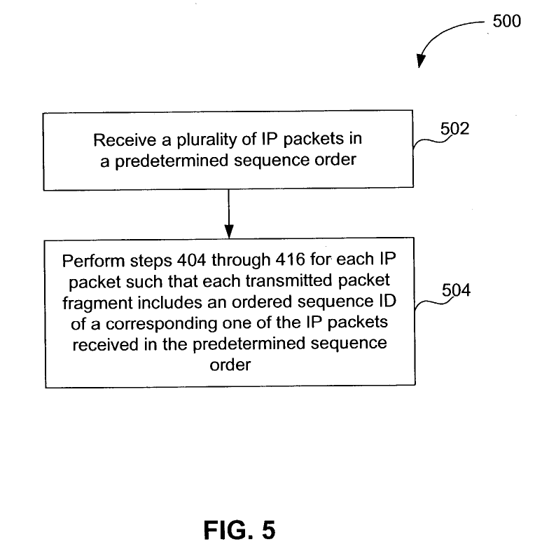

FIG. 5 is a flow chart of additional example transmit method steps 500 performed by mobile and ground portions 202 and 204. Again, the transmit method is described in the context of mobile portion 202. At a first additional transmit step 502, MWT 206 receives a plurality of IP packets in a predetermined sequence order from network 208.

At a next additional transmit step 504, MWT 206 performs steps 404 through 416, discussed above, for each of the IP packets such that each transmitted packet fragment includes an in-order packet sequence ID corresponding to the IP packet to which it belongs.

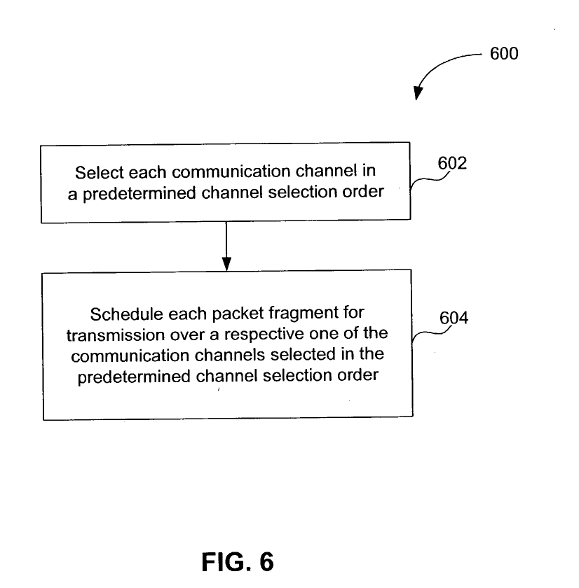

FIG. 6 is a flow chart of an example method 600 expanding on transmit scheduling step 410 of method 400. At a first scheduling step 602, controller 214 selects each of the communication channels 240 in a predetermined channel selection order.

At a next scheduling step 604, controller 214 schedules (that is, assigns) each packet fragment for transmission over a respective one of the communication channels 240 selected in the predetermined channel selection order. For example, a first fragment is assigned to satellite modem 216a for transmission over corresponding satellite link 240a, a second fragment is assigned to satellite modem 216b for transmission over satellite link 240b, and so on, in a “round-robin” fashion.

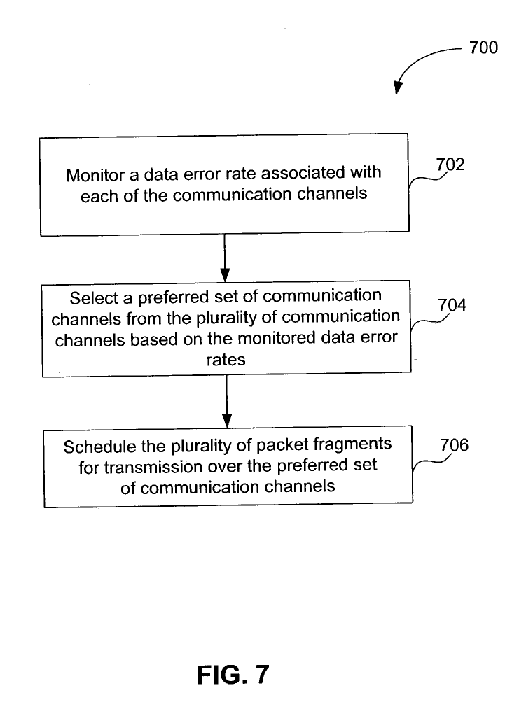

FIG. 7 is a flow chart of an alternative transmit scheduling method 700 corresponding to scheduling step 410. At a first scheduling step 702, controller 214 monitors a data error rate associated with each of the communication channels 240.

At a next scheduling step 704, controller 214 selects a preferred set of communication channels from the plurality of communication channels 240 based on the monitored data error rates. The preferred set of communication channels can include the satellite channels having the lowest data error rates.

At a next step 706, controller 214 schedules the plurality of packet fragments (from step 406) for transmission over the preferred set of communication channels.

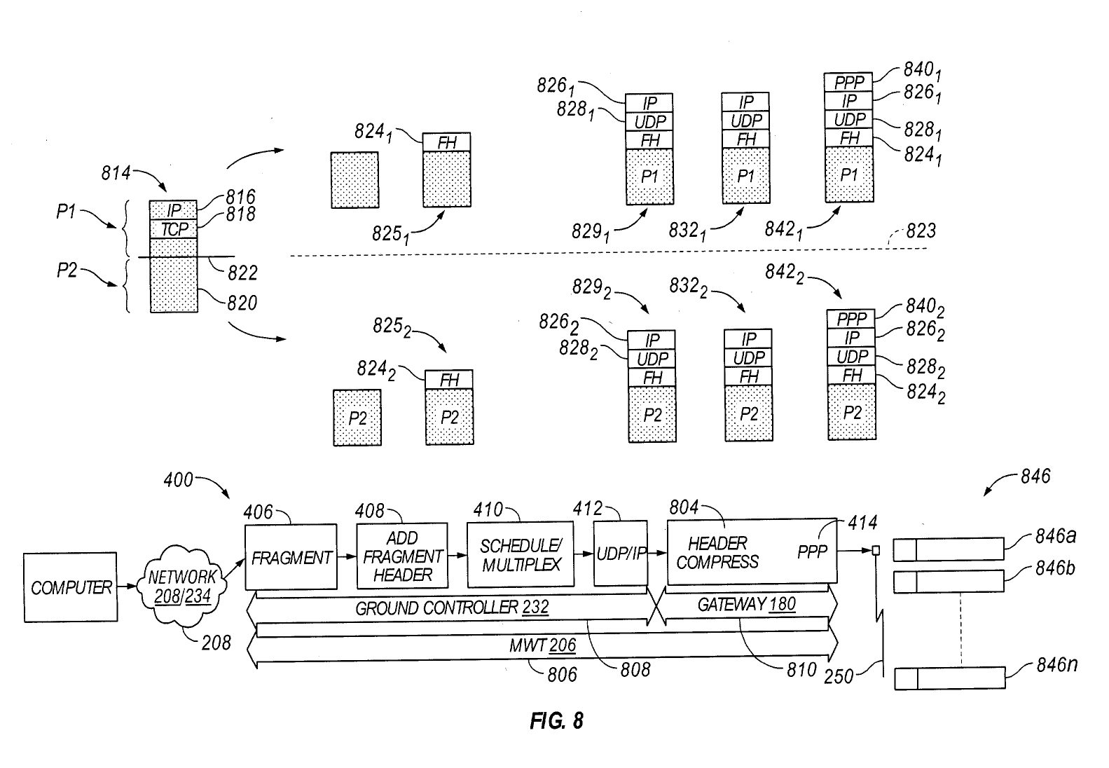

FIG. 8 is an illustration of portions of transmit method 400 along with an exemplary series of packet fragments produced by method 400, useful for describing embodiments of the invention. Method steps 406, 408, 410, 412, an optional header compress step 804, and step 414 of transmit method 400 are depicted from left-to-right in FIG. 8.

In mobile portion 202, all of the above listed transmit method steps can be implemented in MWT 206, as indicated at bi-directional arrow 806 in FIG. 8. On the other hand, in ground portion 204, steps 406, 408, 410 and 412 can be implemented in ground controller 232, as indicated by bi-directional arrow 808, while optional header compress step 804 and step 414 of method 400 can be implemented in gateway 180, as indicated by bi-directional arrow 810. The transmit method steps can be distributed differently in alternative arrangements of the present invention.

With reference to FIG. 8, an example IP packet 814 from network 208 arrives at fragment step 406. IP packet 814 includes an IP header 816, a TCP header 818, and payload data 820.

At step 406, IP packet 814 is divided (that is, fragmented) at 822 into a packet fragment P1 and a packet fragment P2. Fragment P1 is traced from left-to-right in FIG. 8 above a dashed line 823, while fragment P2 is traced below the dashed line 822, as the transmit method steps are executed in sequence.

At step 408, fragment headers (FHs) 824₁ and 824₂ are added to respective fragments P1 and P2, to produce respective packet fragments 825₁ and 825₂. Fragment headers 824₁ and 824₂ each include a different fragment ID, but a common packet sequence ID since both of fragments P1 and P2 belong to common IP packet 814.

Step 412 adds IP headers 826₁, 826₂ and transport protocol (for example, UDP) headers 828₁, 828₂ to respective packet fragments P1, P2, to produce respective packets 829₁, 829₂.

At step 414, link layer (for example, PPP) protocol headers 840₁, 840₂ are added to respective packet fragments P1, P2, to produce respective packet fragments 842₁, 842₂. Optionally, a header compress step 804 can be used in which controller 214 optionally compresses the various headers appended to the packet fragments from step 412, mentioned above, to reduce the size of the packet fragments, and, thus, conserve data transmission bandwidth. Step 804 produces data packets 832₁, 832₂ having compressed headers.

Next, packet fragments P1 and P2 are processed in accordance with a radio link protocol (RLP) as part of a known air interface used by the radio transmitters/transceivers to establish data frames 846a-846n suitable for transmission over air interface 250.

### IV. Receive Methods

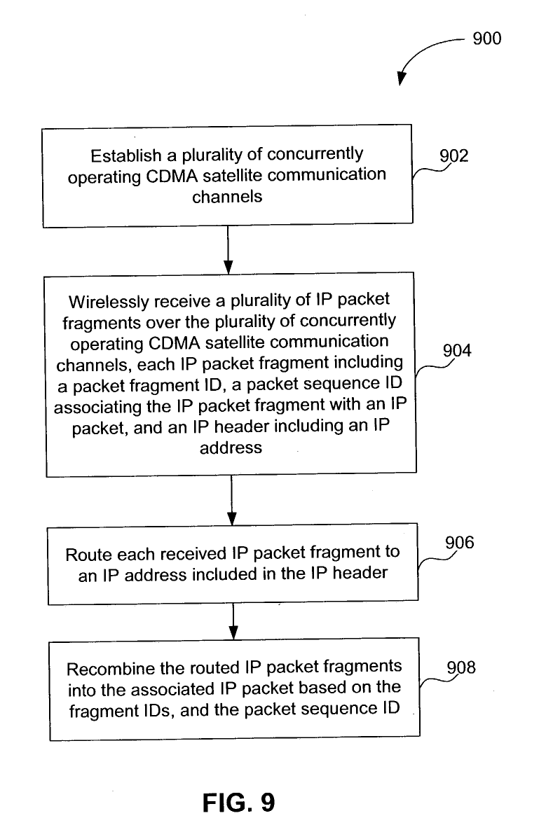

FIG. 9 is a flow chart of an example receive method 900 of aggregating multiple communication channels implemented in mobile and ground portions 202 and 204. The receive method is described in the context of ground portion 204, that is, in direction 310, but the method also applies to mobile portion 202.

At an initial step 902, gateway station 180 establishes a plurality of concurrently operating CDMA satellite communication channels 240.

At a next step 904, gateway station 180 wirelessly receives a plurality of IP packet fragments, transmitted by MWT 206, over the concurrently operating CDMA satellite communication channels 240. Each IP packet fragment includes a packet fragment ID, a packet sequence ID associating the IP packet fragment with an IP packet, and an IP header including an IP address of ground controller 232.

At a next step 906, gateway station 180 sends the IP packet fragments to gateway router 230. Gateway router 230 routes each of the IP packet fragments to the IP address included in the IP header of each packet fragment. That is, router 230 routes each of the IP packet fragments to ground controller 232.

At a next step 908, ground controller 232 recombines the routed IP packet fragments into the associated IP packet based on the fragment IDs and the packet sequence IDs.

During the setup of communication channels, each UDP/IP tunnel associated with a satellite modem, module or transceiver, is assigned a unique IP address. The ground controller uses the IP address associated with the tunnel over which the fragments are transmitted as the destination IP address of the fragments. In this way, packets destined to an MWT transmitted by the ground controller as fragments over multiple tunnels, each with a separate IP address, are routed to the MWT whereby the MWT controller can combine the packet fragments routed thereto.

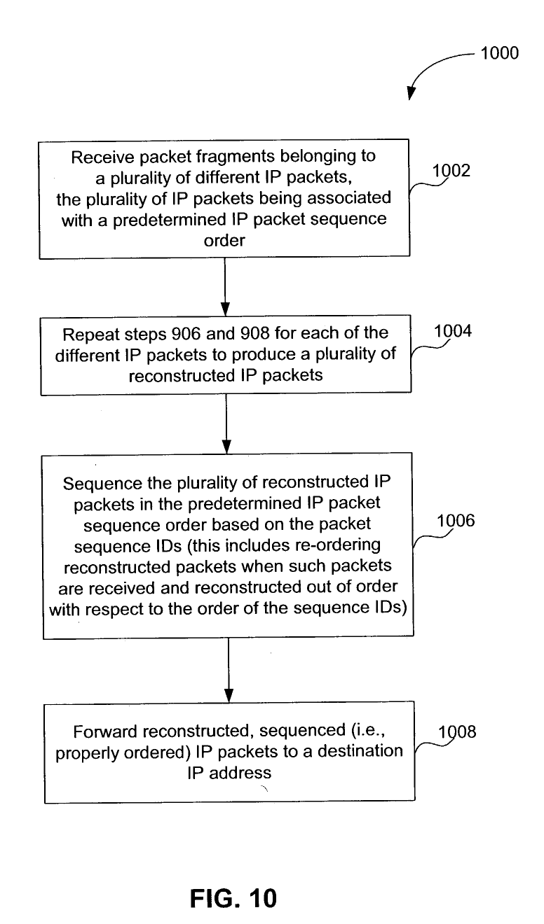

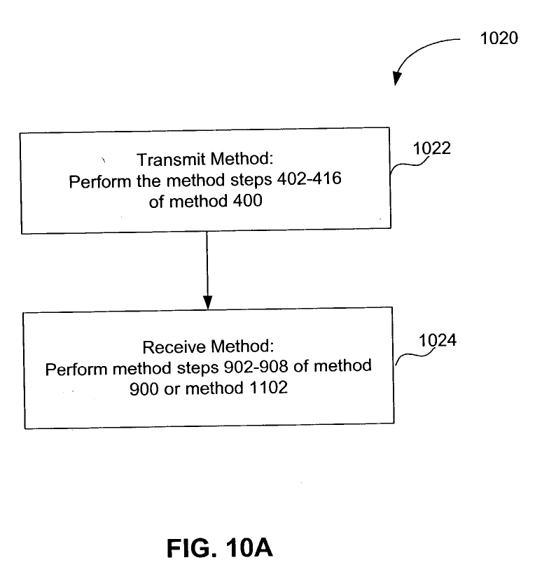

FIG. 10 is a flow chart of additional receive method steps 1000. At an initial additional step 1002, gateway station 180 receives packet fragments belonging to a plurality of different IP packets (for example a plurality of IP packets from data network 208 of mobile portion 202). The plurality of different IP packets are associated with a predetermined IP packet sequence order, for example, the order in which MWT 206 received the IP packets from data network 208.

At a next step 1004, steps 906 and 908 of method 900 are repeated for each of the different IP packets to produce a plurality of reconstructed IP packets at ground controller 232.

At a next step 1006, the ground controller 232 sequences the plurality of reconstructed IP packets in the predetermined IP packet sequence order based on the packet sequence IDs. This includes re-ordering reconstructed packets when the reconstructed packets are out-of-order with respect to the predetermined sequence order established at mobile portion 202, as indicated by the sequence IDs.

Forwarding packet fragments from gateway 180 based on their IP addresses is advantageous because fragment combining and sequencing can occur anywhere on the Internet (or other data network). Thus, packet fragments received by gateway 180 at a first geographical location can be combined and sequenced at a convenient second geographical location remote from the first location.

At a next step 1008, ground controller 232 forwards the reconstructed, sequenced (that is, in-order) IP packets to router 236. Router 236 forwards the IP packets to their destination IP addresses (such as computer terminals 236a-236n).

FIG. 10A is a flow chart of an example method 1020 implemented in either directions 310 or 312 according to embodiments of the invention. Method 1020 includes a first transmit step 1022, representing a collection of transmit method steps, described above. A next receive step 1024 represents a collection of receive method steps, also described above.

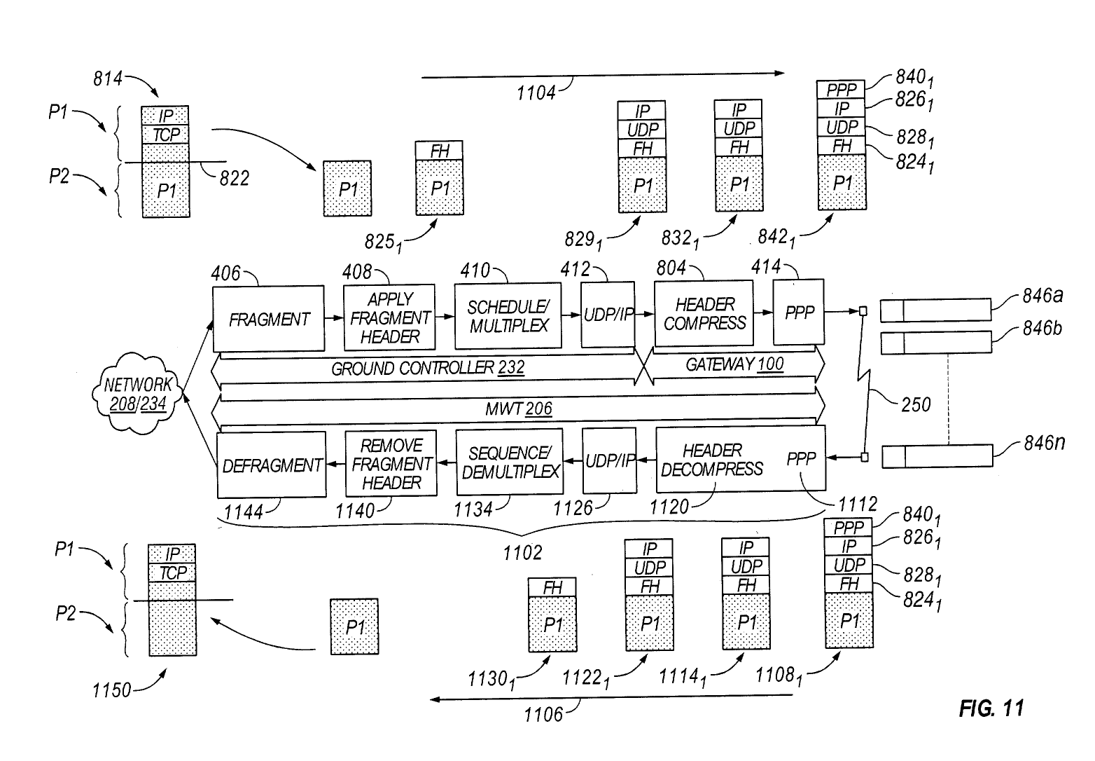

FIG. 11 is an illustration of a receive method 1102 according to an alternative embodiment of the present invention, in combination with the transmit method steps depicted in FIG. 8. Alternative receive method 1102 is similar to receive methods 900 and 1000, described above. Also depicted in FIG. 11 is an illustrative series of received packet fragments resulting from receive method 1102, and an illustrative series of transmit packet fragments (also depicted in FIG. 8) resulting from the transmit method.

In a transmit direction 1104, exemplary packet fragment 814 is fragmented and processed in accordance with transmit method 400, described above. Resulting packet fragments, for example, packet fragment 842₁, are transmitted in satellite frames 846a-846n over air interface 250.

In a receive direction 1106, the packet fragments are received at MWT 206 or gateway station 180, depending on whether gateway station 180 or MWT 206 transmitted the fragments. An example received packet fragment 1108₁, corresponding to transmitted packet fragment 830₁, is first processed in a link layer protocol (for example, PPP) processing step 1112. At step 1112, link layer header 840₁ is removed from received packet 1108₁ to produce a next packet fragment 1114₁.

Packet fragment 1112₁ is next processed at a transport layer protocol (for example, UDP/IP) processing step 1126. At step 1126, IP and transport layer headers 826₁ and 828₁ are removed from packet fragment 1122₁, to produce a packet fragment 1130₁. If header compression was employed in the transmit direction 1104, then packet fragment 1114 is processed at a header decompress step 1120, to produce a packet fragment 1122₁ including decompressed headers.

A next step 1134 sequences/demultiplexes the plurality of packet fragments to produce packet fragments sequenced according to their respective sequence IDs.

At a next step 1140, fragment header 824₁ is removed from packet 1130₁ to produce IP packet fragment P1.

At a next step 1144, the IP packet fragments are assembled into a reconstructed, sequenced IP packet 1150, corresponding to initial IP packet 814. Therefore, receive method 1102 sequences IP packet fragments in accordance with the sequence IDs, and then reconstructs IP packets from the already sequenced packets fragments, whereas receive method 1000 first reconstructs IP packets, and then sequences the reconstructed IP packets.

### V. Protocol Connectivity

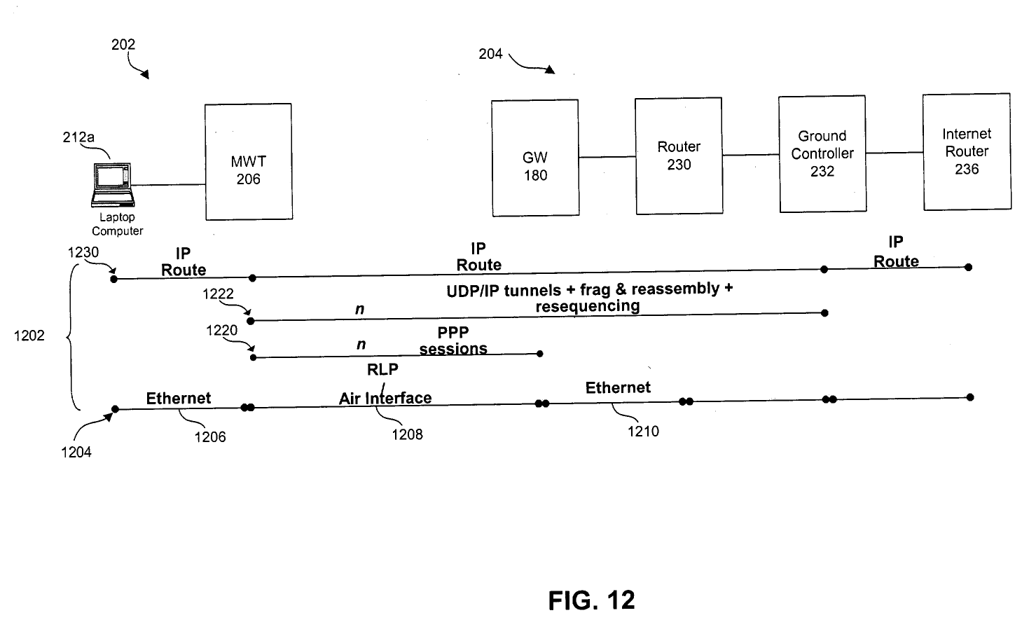

FIG. 12 is a diagram of exemplary layered protocol connections 1202 between various elements of system 200, described above. A lowest/physical layer connectivity thread 1204 includes an Ethernet connection 1206 between terminal 212a and MWT 206. Physical layer 1204 also includes a radio link protocol/air interface connection 1208 (corresponding to air interface 250) between MWT 206 and gateway 180. Physical layer 1204 also includes an Ethernet connection 1210 between gateway 180 and gateway router 230.

Above physical layer 1204, a link layer connectivity thread 1220 includes a plurality, n, of link layer data sessions between MWT 206 and gateway 180. The link layer data sessions are implemented in accordance with an exemplary link layer protocol, such as PPP. Above link layer 1220, a transport/network layer connectivity thread 1222 includes a plurality, n, of transport layer (for example, UDP/IP) data tunnels connecting MWT 206 to ground controller 232. Above layer 1222, an IP network layer connectivity thread 1230 provides IP connectivity between terminal 212a and router 236.

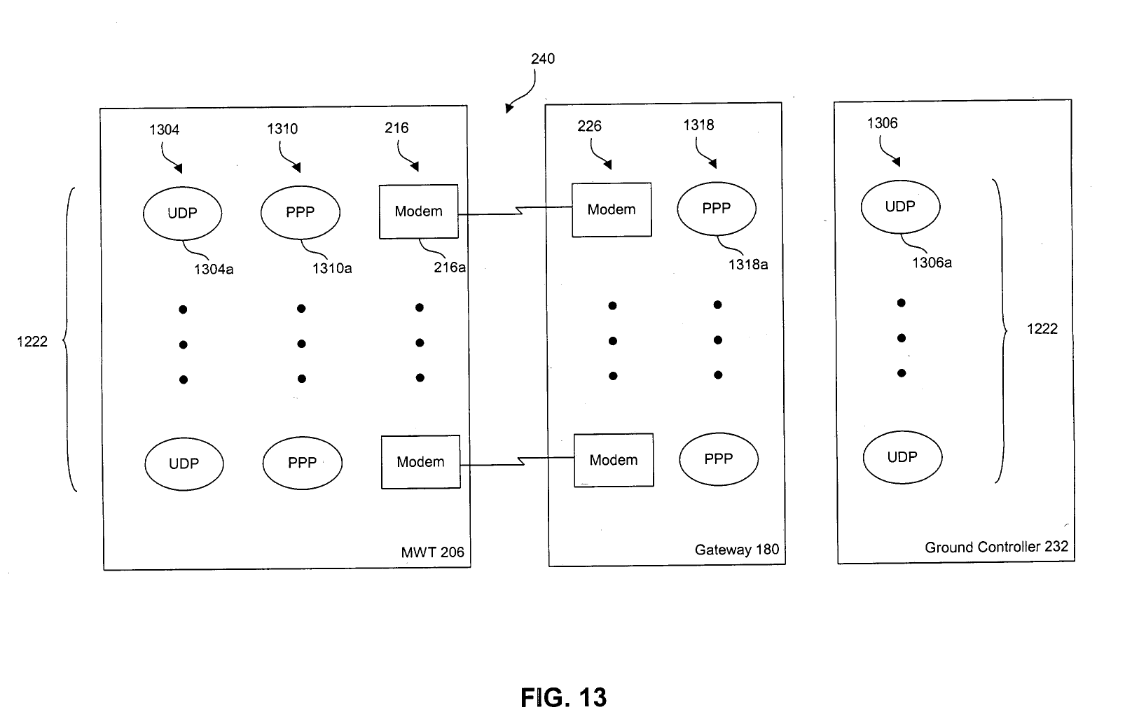

FIG. 13 is an illustration of exemplary UDP/IP data tunnels 1222 connecting MWT 206 with ground controller 232. Each of tunnels 1222 include or has its own PPP session associated with it. Also, each PPP session has its own UDP session, the relationship of PPP to UDP being 1:1. However a PPP or UDP process can have multiple sessions running, which can be referred to as multiple instances on UDP 1304 in MWT 206 and corresponding multiple instances (that is, peer instances) on UDP 1306 in ground controller 232. The UDP sessions reside over multiple instances of PPP 1310 in MWT 206 and corresponding multiple instances (that is, peer instances) of PPP 1318 in gateway 180. The multiple instances on a PPP (1310/1318) operate over corresponding ones of satellite communication channels 240. An exemplary PPP process running on the MWT, can have say 24 sessions.

MWT controller 214 forms an end-point for UDP tunnels 1222 used to route the IP packets to and from the ground portion 204. UDP tunnels 1222 provide a convenient mechanism for multiplexing IP packet fragments across satellite modems 216, as well as sequencing of IP packets at ground controller 232. Ground controller 232 provides another end-point for UDP tunnel 1222. The present invention also provides a single PPP connection/session (for example, 1310a/1306a) per satellite modem (for example, modem 216a). By establishing multiple PPP sessions between MWT 206 and gateway 180, and distributing data-to-be transmitted over air interface 250 between all of the PPP sessions, this achieves effective data transmission at higher rates than might otherwise be possible over air interface 250.

MWT 206 establishes one of communication channels 240 for each of satellite modems 216, and supports one PPP session for each of the satellite modems. In order for MWT 206 to utilize the bandwidth available from all of the satellite communication channels 240, MWT 206 distributes IP packets among several and sometimes all the available PPP sessions, as desired. In ground portion 204, the PPP sessions terminate in gateway 180. Each PPP session has an associated IP address.

In ground portion 204, gateway controller 228 assigns an IP packet fragment received from the Internet (for example, from data network 234) to an appropriate one of satellite modems 226. To do this, gateway controller 228 assigns the received IP packet fragment to the PPP session (and thus to the satellite modem associated with the PPP session) associated with the IP address in the packet fragment IP header. Since the IP address of the terminal equipment connected to MWT 206 (for example, one of computers 216) differs from the IP addresses assigned to the different PPP sessions, the embodiment uses the tunneling mechanism to tunnel IP packets destined for the terminal equipment. Tunneling is achieved with the multiple UDP/IP tunnels 1222, each UDP/IP tunneling having an IP address associated with a corresponding one of the PPP sessions.

Tunneling enables a reduction in packet delay through IP packet fragmenting and IP packet fragment assembly, and in-sequence delivery of IP packets to destination IP addresses, for example, on the Internet. IP Packets transferred to and from the terminal equipment (for example, computers 212 and 236) are tunneled between MWT 206 and ground controller 232. This is done to facilitate re-sequencing of IP packets received over the multiple satellite communication channels before the IP packets are forwarded to final destinations. Such in-sequence delivery of IP packets advantageously avoids an undesirable phenomenon known as the Van Jacobson Fast-Retransmit phenomenon, which can result in lower data throughput.

Transmission delay is another important factor to consider when attempting to maximize IP packet transmission throughput. On a communication link having low data transmission throughput, transmission delays associated with large IP packets tend to dominate the total transmission delay per IP packet. Although multiple IP packets can be sent simultaneously over multiple communication channels, there may be an insufficient number of IP packets to keep all of the available communication channels busy if a characteristic known as the “TCP window” does not grow quickly. A large round trip IP packet transmission delay between communicating terminals can cause the TCP window to grow slowly, resulting in low throughput. Therefore, it is desirable to reduce such IP packet transmission delay, and to thus cause the TCP window to grow quickly. This is achieved here by using multiple communication links, each with its own instantiation of a PPP session, splitting each IP packet into multiple, small IP packet fragments, and concurrently transmitting the fragments over all of the available communication links, thereby reducing the transmission delay of the IP packet. In this manner, the present invention causes the TCP window to grow quickly.

As described above, packet fragments are tunneled over PPP links using UDP/IP headers. For example, if a single IP packet from the terminal equipment (for example, computers 212/236) is split into 5 fragments and sent over five simultaneous PPP sessions using UDP/IP tunnels, it takes ⅕^{th} as much time as it takes to transmit a full IP packet. These packet fragments are reassembled at the other end of the PPP link into the original IP packet after de-tunneling the packets from the UDP/IP tunnels. The tunneling mechanism provides end points (MWT 206 and ground controller 232) where packets are fragmented for transmission over the air, and reassembled before forwarding them onto a final destination.

In the exemplary embodiment described above, the terminal equipment connected to MWT 206 uses IP as the network layer protocol. The protocol layers above the IP layer can be one of several protocols available in the IP protocol suite, as would be understood.

### VI. Controllers

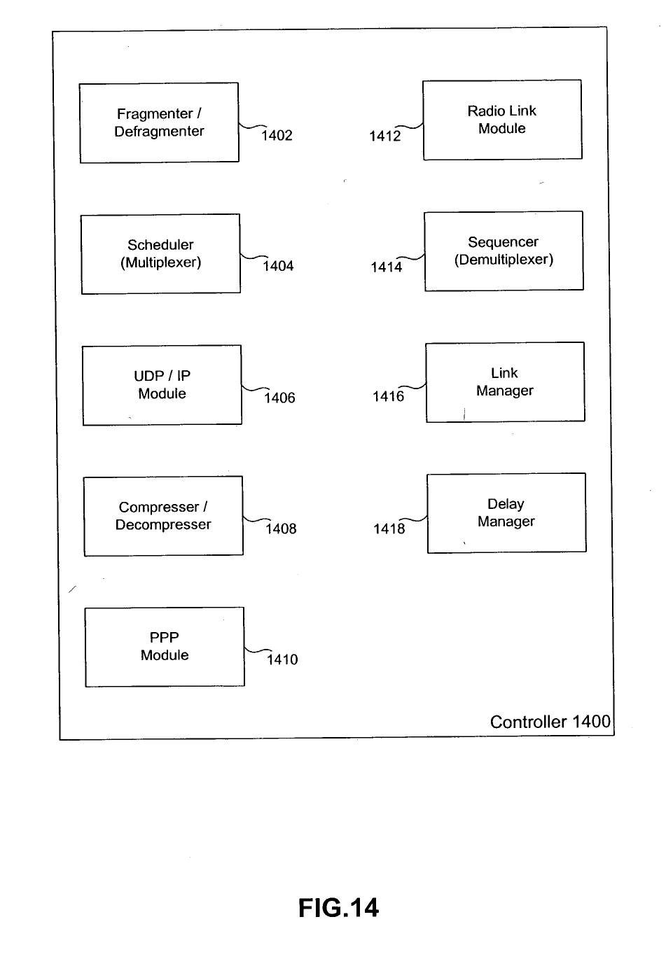

FIG. 14 is a functional block diagram of an example controller (which can also be a plurality of controllers, processors, or processing elements) 1400 representing controller 214 in MWT 206, and controllers 228 and 232 together in ground portion 204. Controller 1400 includes the following controller modules for executing the methods of the present invention:

a fragmenter/defragmenter 1402 to fragment IP packets into packet fragments in the transmit direction and de-fragment (or assemble) such packet fragments into reconstructed IP packets in the receive direction;

a scheduler/multiplexer 1404 to schedule the transmission of IP packet fragments;

a transport-protocol/IP module 1406 to implement transport protocols. Module 1406 applies transport layer and IP layer headers to packet fragments in the transmit direction and remove the same from packet fragments in the receive direction;

a link layer protocol module 1410 to implement link layer protocols over satellite channels 240. Module 1410 applies link layer protocol headers to packet fragments in the transmit direction and removes the same from packet fragments in the receive direction, potentially with an optional compressor/decompressor 1408 to compress various headers on IP packet fragments in the transmit direction and to decompress the same in the receive direction;

a radio link module 1412 to transmit and receive data over satellite channels 240 in accordance with satellite link protocols (that is, radio link protocols);

a sequencer/demultiplexer 1414 to sequence reconstructed IP packets (and packet fragments) in accordance with the packet sequence ID appended to each packet fragment;

a link manager 1416 to establish and clear satellite communication links. Link manager 1416 also monitors satellite link data error rates; and

a delay manager 1418 to monitor delay times between transmitted and re-transmitted packet fragments.

All of the above-listed controller modules 1402-1418 can reside in MWT 206 of mobile portion 202. On the other hand, controller modules 1402-1418 are distributed among ground portion controllers 228 and 232. For example, controller modules 1404, 1408, 1410 and 1412 can reside in gateway controller 228, while controller modules 1402, 1404, 1406, 1414, 1416, and 1418 can reside in ground controller 232. Other controller module distributions are possible.

### VII. Computer System

The methods of the present invention are implemented using controllers (for example, MWT controller 214, gateway controller 228, and a controller in ground controller 232) operating in the context of computer based systems. Each of these controllers represents one or more controllers. Although communication-specific hardware can be used to implement the present invention, the following description of a general purpose computer system is provided for completeness. The present invention is preferably implemented in a combination of software executed by controllers 214, 228, and 232, and hardware. Consequently, aspects of the invention may be implemented in a computer system or other processing system including but not limited to dedicated processors, microprocessors, and so forth.

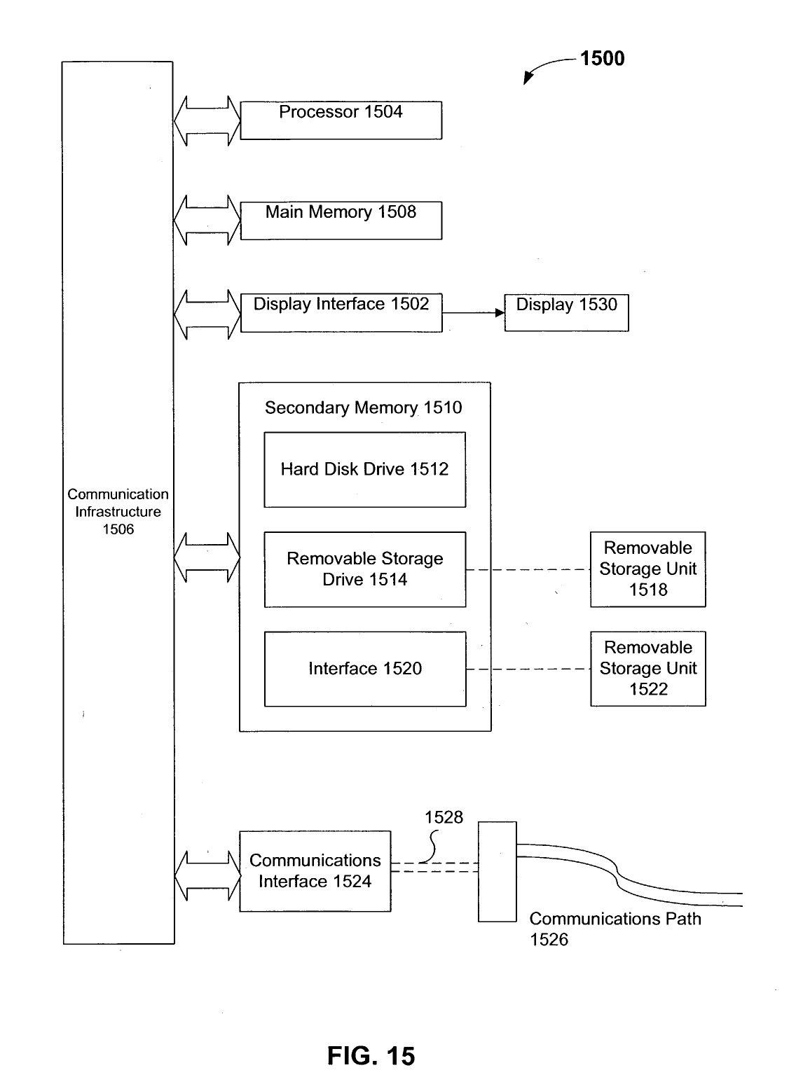

An example of such a computer system 1500 is shown in FIG. 15. In the present invention, the above described methods or processes, for example, methods 400-1020, including method steps executed on computer system 1500 (a separate computer system 1500 is associated with each of controllers 214, 228, and 232). The computer system 1500 includes one or more processors. The processor 1504 is connected to a communication infrastructure 1506 such as a bus, including an address bus and a data bus, and/or a data network. Various software implementations are described in terms of this exemplary computer system. After reading this description, it will become apparent to a person skilled in the relevant art how to implement the invention using other computer systems and/or computer architectures.

Computer system 1500 also includes a main memory 1508, preferably random access memory (RAM), and may also include a secondary memory 1510. The secondary memory 1510 may include, for example, a hard disk drive 1512 and/or a removable storage drive 1514, representing a floppy disk drive, a magnetic tape drive, an optical disk drive, etc. The removable storage drive 1514 reads from and/or writes to a removable storage unit 1518 in a well known manner. Removable storage unit 1518, represents a floppy disk, magnetic tape, optical disk, etc. which is read by and written to by removable storage drive 1514. As will be appreciated, the removable storage unit 1518 includes a computer usable storage medium having stored therein computer software and/or data.

In alternative implementations, secondary memory 1510 may include other similar means for allowing computer programs or other instructions to be loaded into computer system 1500. Such means may include, for example, a removable storage unit 1522 and an interface 1520. Examples of such means may include a program cartridge and cartridge interface (such as that found in video game devices), a removable memory chip (such as an EPROM, or PROM) and associated socket, and other removable storage units 1522 and interfaces 1520 which allow software and data to be transferred from the removable storage unit 1522 to computer system 1500.

Computer system 1500 may also include a communications interface 1524. Communications interface 1524 allows software and data to be transferred between computer system 1500 and external devices. Examples of communications interface 1524 may include a modem, a network interface (such as an Ethernet card), a communications port, a PCMCIA slot and card, special USB port, etc. Other examples include, but are not limited to, wireless Ethernet connections provided by circuits manufactured in accordance with the Institute of Electrical and Electronics Engineers (IEEE) standards referred to as 802.11, 802.11b, or 802.11a, a well known newer interface standard for wireless communications referred to as “Bluetooth.” These types of devices provide portals or connections (nodes) to networks for wireless transfer of signals using devices connected physically to networks that operate as hubs or base stations for the wireless devices. Such apparatus or devices are known in the art. Software and data transferred via communications interface 1524 are in the form of signals 1528 which may be electronic, electromagnetic, optical or other signals capable of being received by communications interface 1524. These signals 1528 are provided to communications interface 1524 using a communications path 1526. Communications path 1526 carries signals 1528 and may be implemented using wire or cable, fiber optics, a phone line, a cellular phone link, an RF link and other communications channels.

In this document, the terms “computer program medium” and “computer usable medium” are used to generally refer to media such as removable storage drive 1514, a hard disk installed in hard disk drive 1512, and signals 1528. These computer program products are means for providing software to computer system 1500.

Computer programs (also called computer control logic) are stored in main memory 1508 and/or secondary memory 1510. Computer programs may also be received over communications interface 1524. Such computer programs, when executed, enable the computer system 1500 to implement the present invention as discussed herein. In particular, the computer programs, when executed, enable the processor 1504 to implement the process of the present invention. Accordingly, such computer programs represent controllers of the computer system 1500. By way of example, in an embodiment of the invention, the processes performed by controllers 214, 228, and 232 can be performed by computer control logic. Where the invention is implemented using software, the software may be stored in a computer program product and loaded into computer system 1500 using removable storage drive 1514, hard drive 1512 or communications interface 1524.

### VIII. Conclusion

While various embodiment of the present invention have been described above, it should be understood that they have been presented by way of example only, and not limitation. Thus, the breadth and scope of the present invention should not be limited by any of the above-described exemplary embodiments and arrangements, but should be defined only in accordance with the following claims and their equivalents.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, gate arrays, processors executing appropriate software and the like or many combinations thereof. Thus, the breadth and scope of the present invention should not be limited by any of the above-described exemplary embodiments, but should be defined only in accordance with the following claims and their equivalents.

What we claim as our invention is:

1. A method of aggregating multiple Code Division Multiple Access (CDMA) communication channels, comprising:
(a) receiving at least one Internet Protocol (IP) data packet;
(b) fragmenting the IP data packet into a plurality of packet fragments smaller than the IP data packet;
(c) adding a fragment identifier (ID) and a packet sequence ID to each packet fragment;
(d) adding an IP header to each packet fragment, the IP header including an IP address; and
(e) wirelessly transmitting the plurality of packet fragments over a plurality of concurrently operating CDMA communication channels.

2. The method of claim 1, wherein step (a) comprises receiving a plurality of IP data packets in a predetermined sequence order, the method further comprising:
(f) performing steps (b) through (e) for each IP data packet such that each transmitted packet fragment includes a sequence ID of a corresponding one of the IP data packets received in the predetermined sequence order.

3. The method of claim 1, wherein step (e) comprises:
concurrently transmitting at least two of the plurality of packet fragments over corresponding ones of the concurrently operating communication channels.

4. The method of claim 1, wherein step (d) comprises adding a transport protocol header to each packet fragment in addition to the IP header, the transport protocol header corresponding to a respective one of the communication channels over which the packet fragment is to be transmitted in step (e).

5. The method of claim 1, wherein each of the CDMA communication channels includes a satellite communication link, and step (e) comprises transmitting the plurality of packet fragments over the plurality of satellite communication links.

6. The method of claim 1, further comprising, prior to step (e):
establishing each of the concurrently operating CDMA communication channels.

7. The method of claim 1, further comprising, prior to step (e):
scheduling each said packet fragment for transmission over a selected one of the plurality of concurrently operating CDMA communication channels.

8. The method of claim 7, wherein said scheduling step comprises:
selecting each said communication channel in a predetermined channel selection order; and
scheduling each said packet fragment for transmission over a respective one of the communication channels selected in the predetermined channel selection order.

9. The method of claim 7, wherein said scheduling step comprises:
monitoring a data error rate associated with each of the communication channels;
selecting a preferred set of communication channels from the plurality of communication channels based on the monitored data error rates; and
scheduling the plurality of packet fragments for transmission over the preferred set of communication channels.

10. A method of aggregating multiple Code Division Multiple Access (CDMA) communication channels, comprising:
(a) wirelessly receiving a plurality of Internet Protocol (IP) packet fragments over a plurality of concurrently operating CDMA communication channels, each IP packet fragment including a packet fragment identifier (ID), a packet sequence ID associating the IP packet fragment with an IP data packet, and an IP header including an IP address;
(b) routing each received IP packet fragment to the IP address included in the IP header; and
(c) combining the routed IP packet fragments into the associated IP data packet based on the fragment IDs and the packet sequence IDs.

11. The method of claim 10, wherein the plurality of IP packet fragments received in step (a) are associated with a plurality of different IP data packets, the method further comprising:
(d) repeating steps (b) and (c) for each of the different IP data packets to produce a plurality of reconstructed IP data packets; and
(e) sequencing the plurality of reconstructed IP data packets based on the packet sequence IDs.

12. The method of claim 11, wherein step (e) comprises reordering the plurality of reconstructed IP data packets when the reconstructed IP data packets from step (d) are out-of-order with respect to a predetermined sequence order indicated by the packet sequence IDs.

13. The method of claim 10, wherein the plurality of IP packet fragments received in step (a) are associated with a plurality of different IP data packets, the method further comprising:
repeating steps (b) and (c) for each of the different IP data packets to produce a plurality of reconstructed IP data packets in a packet sequence ordered in accordance with the sequence IDs, wherein step (c) comprises, prior the combining step, sequencing the plurality of packet fragments according to the packet sequence IDs such that the combining step produces the reconstructed IP data packets in the packet sequence order.

14. The method of claim 10, wherein step (a) comprises:
concurrently receiving at least two of the plurality of packet fragments over corresponding ones of the concurrently operating communication channels.

15. The method of claim 10, further comprising, prior to step (a):
establishing each of the concurrently operating CDMA communication channels.

16. The method of claim 10, wherein each of the CDMA communication channels includes a satellite communication link.

17. A method of aggregating multiple Code Division Multiple Access (CDMA) communication channels, comprising:
(a) receiving at least one Internet Protocol (IP) data packet;
(b) fragmenting the IP data packet into a plurality of packet fragments smaller than the IP data packet;
(c) adding a fragment identifier (ID) and a packet sequence ID to each packet fragment;
(d) adding an IP header to each packet fragment, the IP header including an IP address;
(e) wirelessly transmitting the plurality of packet fragments over a plurality of concurrently operating CDMA communication channels;
(f) wirelessly receiving the plurality of IP packet fragments;
(g) routing each received IP packet fragment to the IP address included in the IP header; and
(h) recombining the routed IP packet fragments into the at least one IP data packet based on the fragment IDs and the packet sequence IDs.

18. The method of claim 17, wherein step (a) comprises receiving a plurality of IP data packets in a predetermined sequence order, and steps (b) through (h) are repeated for each of the plurality of IP data packets to produce a plurality of reconstructed IP data packets, the method further comprising:
(i) sequencing the plurality of reconstructed IP data packets in the predetermined sequence order based on the packet sequence IDs.

19. A transmit system used for aggregating multiple Code Division Multiple Access (CDMA) communication channels, comprising:
one or more controllers adapted to receive at least one Internet Protocol (IP) data packet, at least one of the one or more controllers having:
a fragmenter that fragments the IP data packet into a plurality of packet fragments smaller than the IP data packet, and that adds a fragment identifier (ID) and a packet sequence ID to each packet fragment, and
an IP module that adds an IP header including an IP address to each packet fragment; and
a plurality of wireless modems adapted to wirelessly transmit the plurality of packet fragments over corresponding ones of a plurality of concurrently operating CDMA communication channels.

20. The system of claim 19, wherein:
the one or more controllers are adapted to receive a plurality of IP data packets in a predetermined sequence order;
the fragmenter is adapted to fragment each of the plurality of IP data packets into a plurality of smaller IP packet fragments, and to add to each of the packet fragments a fragment ID and a packet sequence ID corresponding to the predetermined sequence order; and
the IP module is adapted to add an IP header including an IP address to each of the packet fragments,
wherein the plurality of wireless modems are adapted to transmit the packet fragments belonging to the plurality of IP data packets over the corresponding concurrently operating CDMA channels.

21. The system of claim 19, wherein the one or more controllers are adapted to cause at least two of the wireless modems to concurrently transmit at least two of the plurality of packet fragments over corresponding ones of the concurrently operating communication channels.

22. The system of claim 19, wherein the IP module is adapted to add a transport protocol header to each packet fragment in addition to the IP header, the transport protocol header corresponding to a respective one of the wireless modems and communication channels over which the packet fragment is to be transmitted.

23. The system of claim 19, wherein each of the wireless modems is a satellite modem adapted to transmit CDMA satellite communication signals.

24. The system of claim 19, wherein the one or more controllers are adapted to establish each of the concurrently operating CDMA communication channels.

25. The system of claim 19, wherein at least one of the one or more controllers includes a scheduler that schedules each said packet fragment for transmission over a selected one of the plurality of concurrently operating CDMA communication channels.

26. The system of claim 25, wherein the scheduler includes:
means for selecting each said communication channel in a predetermined channel selection order; and
means for scheduling each said packet fragment for transmission over respective ones of the communication channels selected in the predetermined channel selection order.

27. The system of claim 25, wherein:
at least one of the controllers includes:
means for monitoring a data error rate associated with each of the communication channels; and
the scheduler includes:
means for selecting a preferred set of communication channels from the plurality of communication channels based on the monitored data error rates, and
means for scheduling the plurality of packet fragments for transmission over the preferred set of communication channels.

28. The system of claim 19, wherein the one or more controllers and the wireless modems reside in a mobile wireless terminal.

29. The system of claim 19, wherein the one or more controllers are divided among a gateway station and a ground controller both connected to one or more ground-based packet data networks, and the wireless modems reside in the gateway station.

30. A receive system for aggregating multiple Code Division Multiple Access (CDMA) communication channels, comprising:
a plurality of wireless modems adapted to wirelessly receive a plurality of Internet Protocol (IP) packet fragments over a plurality of concurrently operating CDMA communication channels, each of the communication channels corresponding to a respective one of the wireless modems, each of the packet fragments including a fragment identifier (ID), a packet sequence ID associating the IP packet fragment with an IP data packet, and an IP header including an IP address; and
one or more controllers, at least one of the one or more controllers having:
means for routing each received packet fragment to the IP address included in the IP header, and
a defragmenter that recombines the routed IP packet fragments into the associated IP data packet based on the fragment IDs and the packet sequence IDs.

31. The system of claim 30, wherein the plurality of packet fragments are associated with a plurality of different IP data packets, and wherein:
the routing means is adapted to route each of the packet fragments belonging to each of the plurality of different IP data packets to the IP address of the channel over which it is transmitted;
the defragmenter is adapted to recombine the routed packet fragments into associated IP data packets, thereby producing a plurality of reconstructed IP data packets; and
at least one of the one or more controllers includes a sequencer that sequences the plurality of reconstructed IP data packets based on the packet sequence IDs.

32. The system of claim 30, wherein the plurality of wireless modems are adapted to concurrently receive at least two of the plurality of packet fragments over corresponding ones of the concurrently operating communication channels.

33. The system of claim 30, wherein the one or more controllers establishes each of the concurrently operating CDMA communication channels.

34. The system of claim 30, wherein each of the wireless modems is a satellite modem adapted to receive CDMA satellite signals over the corresponding CDMA communication channel.

35. The system of claim 30, wherein the one or more controllers and the wireless modems reside in a mobile wireless terminal.

36. The system of claim 30, wherein the one or more controllers are divided among a gateway station and a ground controller both connected to one or more ground-based packet data networks, the ground controller having an IP address corresponding to the IP addresses included in the IP packet fragment header, and wherein the wireless modems reside in the gateway station.

37. A system used for aggregating multiple Code Division Multiple Access (CDMA) communication channels, comprising:
a mobile wireless terminal (MWT) including:
one or more (MWT) controllers adapted to receive at least one Internet Protocol (IP) data packet, at least one of the one or more controllers having:
a fragmenter that fragments the IP data packet into a plurality of packet fragments smaller than the IP data packet, and that adds a fragment identifier (ID) and a packet sequence ID to each packet fragment, and
an IP module that adds an IP header to each packet fragment, the IP header including an IP address, and
a first plurality of wireless modems adapted to wirelessly transmit the plurality of packet fragments over corresponding ones of a plurality of concurrently operating CDMA satellite communication channels;
a receiving station including a second plurality of wireless modems adapted to receive the packet fragments over the satellite communication channels, the receiving station including means for routing each of the packet fragments over a network based on the packet fragment IP address; and
a ground controller having an IP address corresponding to the packet fragment IP addresses, the ground controller being adapted to receive the packet fragments from the network, the ground controller including a defragmenter to combine the packet fragments into a reconstructed IP data packet based on the fragment IDs and the packet sequence IDs.
